(19) United States
(12) Patent Application Publication
(10) Pub. No.: US 2010/0202511 A1
(43) Pub. Date: Aug. 12, 2010

(54) METHOD FOR REDUCING ARBITRARY-RATIO UP-SAMPLING OPERATION USING CONTEXT OF MACROBLOCK, AND METHOD AND APPARATUS FOR ENCODING/DECODING BY USING THE SAME

(75) Inventors: Il Hong Shin, Daejeon (KR); Hae-Chul Choi, Daejeon (KR); Gyeong Il Lee, Daejeon (KR); Jeong Ju Yoo, Daejeon (KR); Jin Woo Hong, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/738,351

(22) PCT Filed: Sep. 17, 2008
(86) PCT No.: PCT/KR2008/005477

§ 371 Date: Apr. 16, 2010

(30) Foreign Application Priority Data
Oct. 23, 2007 (KR) 10-2007-0106697

(51) Int. Cl. H04N 7/50

(52) U.S. Cl. 375/240.02; 375/240.24; 375/240.13; 375/E07.211

(57) ABSTRACT

Disclosed are a method for effectively up-sampling an image using information of neighboring blocks, and a method and apparatus of scalable video encoding/decoding using the same. The method for up-sampling a low resolution image corresponding to a high resolution image having an arbitrary image up-sampling ratio includes determining whether the low resolution image is inter-mode data, and performing an image up-sampling adaptively according to a macroblock mode of the low resolution image, when the low resolution image is the inter-mode data.

### TECHNICAL FIELD

The present invention relates to a method for up-sampling a video signal, and more particularly, to a method for effectively up-sampling an image using information about neighboring blocks, and a method and apparatus of scalable video encoding/decoding using the same.

This work was supported by the IT R&D program of MIC/IITA. [2005-S-103-03, Development of Ubiquitous Content Access Technology for Convergence of Broadcasting and Communications]

### BACKGROUND ART

A Scalable Video Codec (SVC) scheme encodes a video signal so as to have superior image quality to thereby generate a picture sequence, so that an image having a relatively low image quality can be expressed even when a partial sequence of the generated picture sequence is decoded. The partial sequence denotes a sequence of a frame intermittently selected from the entire sequence.

In general, a Hierarchical B (H-B) picture scheme is used for the SVC scheme.

FIG. 1 is a block diagram illustrating a structure of a general SVC.

An original video is divided into a plurality of layers in which the original resolutions (size of a screen) are different from one another, and each of the plurality of layers is independently encoded. In this instance, the plurality of layers may be encoded in an identical manner or in a different manner to/from one another.

A picture sequence encoded by the H-B picture scheme receives and decodes only a partial sequence, and thus may be able to express an image having a low image quality. However, when a bit rate of a video signal is reduced, the image quality is significantly deteriorated.

To solve the above-described problem, a separate auxiliary picture sequence for a low transmission rate, that is, a picture sequence in which a number of frames per each second are relatively smaller may be hierarchically provided.

Also, a process for down-sampling and up-sampling an image are required in order to simultaneously transmit an image having a relatively low resolution and an image having a relatively high resolution. In this instance, the image having the relatively low resolution corresponds to a low-order layer having a relatively small size. Specifically, a single original video may be encoded into three picture sequences such as 4 times Common Intermediate Format (4CIF), CIF and Quarter CIF (QUIF) of an image resolution, respectively, to thereby transmit the encoded three picture sequences to a decoder.

A low-order layer and a high-order layer having different resolutions from each other may be acquired by encoding an identical original video, and thus redundancy exists in the original video, that is, encoded data.

Thus, in order to enhance a coding rate of an arbitrary layer, a video signal of the arbitrary layer may be predicted using a data stream acquired by encoding a low-order layer having less resolution than the arbitrary layer. A prediction operation is performed with respect to an image frame of the high-order layer to thereby generate a residual block, that is, a block encoded to have residual data, with respect to a macroblock (MB) within an arbitrary frame. In this instance, the prediction operation is also performed with respect to an image frame of the low-order layer to thereby generate a residual block of the low-order layer. Next, a corresponding residual block of the low-order layer encoded so as to correspond to the MB and have the residual data is enlarged with a magnification corresponding to a resolution ratio between the high-order layer and the low-order layer to thereby have the same size as the MB. In this instance, the corresponding residual block of the low-order layer denotes an area encoded to have the residual data in such a manner that a number of pixels of vertical and horizontal direction corresponds to ½ of the MB, respectively. Next, a pixel value of the enlarged corresponding residual block of the low-order layer is subtracted from a pixel value of a residual block of the high-order layer to thereby be encoded in the MB of the high-order layer.

The enlarged corresponding residual block is not transmitted to the decoder. As a result, the decoder performs an enlargement so as to decode the encoded MB, and then a value acquired by performing the enlargement is added to a residual value of the high-order layer to thereby restore the residual block.

Also, a process for enlarging a block of the low-order layer is required even for performing a residual data prediction operation between layers as well as for encoding the MB.

In the case of enlarging the residual block of the low-order layer according to the above-described conventional art, an operation amount of up-sampling is significantly increased at the time of performing the up-sampling due to up-sampling images of all the low-order layers.

H.264 SVC supports a screen resolution having an arbitrary ratio to be different with that of a conventional MPEG-2 Scalable Video Coding. For example, a low-order layer image of 240×192 and a high-order layer image of 320×256 having an arbitrary ratio of 4/3 therebetween may be encoded. To this end, an Extended Spatial Scalability (ESS) Tool has to be supported. The ESS Tool is composed of a 4-tap interpolation filter and a portion for processing phase information between the low-order layer and the high-order layer. Specifically, the phase of the interpolation filter is calculated using an arbitrary image up-sampling ratio with respect to pixels intended to be currently enlarged to thereby select an appropriate 4-tap filter, and then a convolution process is performed in the vertical and horizontal direction, respectively, to thereby perform an image up-sampling.

### DISCLOSURE OF INVENTION

### Technical Problem

An aspect of the present invention provides a method for up-sampling an image, which can reduce an operation amount of up-sampling using information about neighboring blocks at the time of encoding and decoding a scalable video.

An aspect of the present invention provides scalable video encoding/decoding apparatuses and methods which can reduce an operation amount of encoding and decoding using information about neighboring blocks at the time of encoding and decoding a scalable video.

### Technical Solution

According to an aspect of the present invention, there is provided a method for up-sampling a low resolution image corresponding to a high resolution image having an arbitrary image up-sampling ratio, which includes: determining whether the low resolution image is inter-mode data; and performing an image up-sampling adaptively according to a macroblock mode of the low resolution image, when the low resolution image is the inter-mode data.

In this instance, the performing may include: determining whether an arbitrary macroblock of the low resolution image and respective neighboring macroblocks adjacent to the arbitrary macroblock are an intra-macroblock; and up-sampling the arbitrary macroblock when at least one of the arbitrary macroblock and the respective neighboring macroblocks is the intra-macroblock.

In this instance, the method for up-sampling an image may be applicable to an operation for enlarging a block of a low-order layer in the case of performing a residual data prediction operation between layers, and in particular, to scalable video encoding/decoding apparatuses and methods.

According to an aspect of the present invention, there is provided a scalable video encoding apparatus, which includes: a low-order layer encoding unit for encoding a low resolution image corresponding to an arbitrary high resolution image; an image up-sampling unit for up-sampling an image adaptively according to a macroblock mode of the encoded low resolution image; and a high-order layer encoding unit for encoding the high resolution image using a difference between the up-sampled image and the high resolution image.

According to an aspect of the present invention, there is provided a scalable video decoding apparatus, which includes: a low-order layer decoding unit for decoding a low resolution image corresponding to an arbitrary high resolution image; an image up-sampling unit for up-sampling an image adaptively according to a macroblock mode of the decoded low resolution image; and a high-order layer decoding unit for decoding the high resolution image using the up-sampled image and a residual encoded data of the high resolution image.

### BRIEF DESCRIPTION OF THE DRAWINGS

FIG. 1 is a block diagram illustrating a structure of a conventional Scalable Video Codec (SVC);

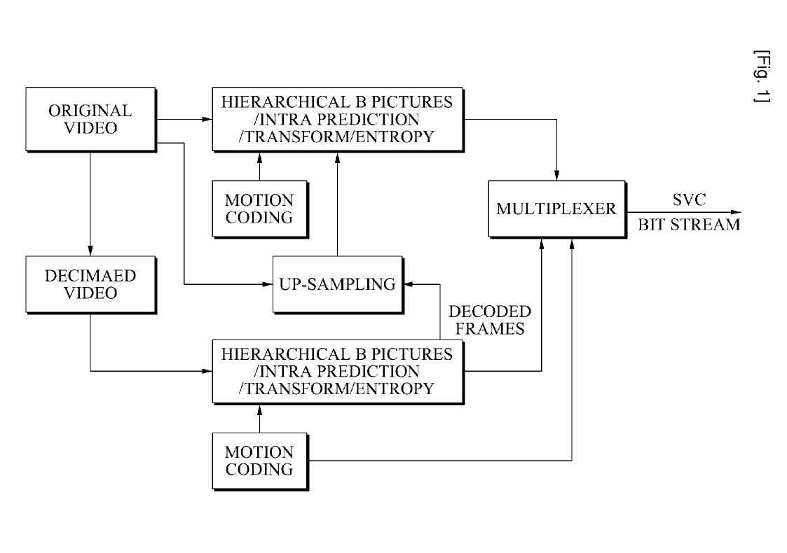

FIGS. 2 and 3 are block diagrams illustrating schematic structure of scalable video encoding/decoding apparatuses according to an exemplary embodiment of the present invention;

FIG. 4 is a block diagram illustrating a process for up-sampling an image of a low-order layer;

FIG. 5 is a flowchart illustrating a scalable video encoding/decoding method according to an exemplary embodiment of the present invention;

FIG. 6 is a flowchart illustrating an adaptive image up-sampling operation process of FIG. 4, in detail;

FIG. 7 is a flowchart illustrating a method for up-sampling an image according to an exemplary embodiment of the present invention;

FIG. 8 is a flowchart illustrating a method for up-sampling an image according to another exemplary embodiment of the present invention; and

FIG. 9 is a diagram illustrating an example of eight neighboring macroblocks (MBs) of a current macroblock.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

A method for up-sampling a low resolution image corresponding to a high resolution image having an arbitrary image up-sampling ratio according to an exemplary embodiment includes determining whether the low resolution image is inter-mode data, and performing an image up-sampling adaptively according to a macroblock (hereinafter referred to as MB) mode of the low resolution image, when the low resolution image is the inter-mode data.

As described above, the method for up-sampling the low resolution image corresponding to the high resolution image may be applicable at the time of encoding/decoding a scalable video, and a scalable video encoding/decoding process will be hereinafter described in detail.

Also, the present invention is assumed to be applicable either in a case where an up-sampling ratio of an image in a H.264 Scalable Video Codec (SVC) arbitrary ration, that is, a ratio of the horizontal length to the vertical length of each of a high-order layer and a low-order layer is a positive number ratio, or in a case where the up-sampling ratio is not a positive number ratio.

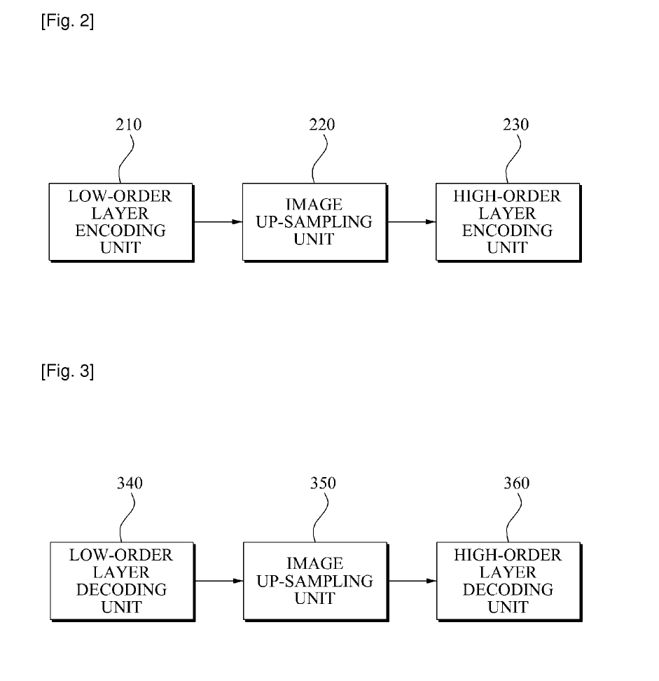

FIGS. 2 and 3 are block diagrams illustrating schematic structure of scalable video encoding/decoding apparatuses according to an exemplary embodiment of the present invention.

Referring to FIG. 2, the scalable video encoding apparatus includes a low-order layer encoding unit 210 for encoding a low resolution image corresponding to an arbitrary high resolution image, an image up-sampling unit 220 for up-sampling an image adaptively according to a MB mode of the encoded low resolution image, and a high-order layer encoding unit 230 for encoding the high resolution image using a difference between the up-sampled image and the high resolution image.

Also, referring to FIG. 3, the scalable video decoding apparatus includes a low-order layer decoding unit 340 for decoding a low resolution image corresponding to an arbitrary high resolution image, an image up-sampling unit 350 for up-sampling an image adaptively according to a MB mode of the decoded low resolution image; and a high-order layer decoding unit 360 for decoding the high resolution image using the up-sampled image and a residual encoded data of the high resolution image.

The low-order layer encoding unit 210 and the low-order layer decoding unit 340 encodes/decodes the low resolution image, respectively.

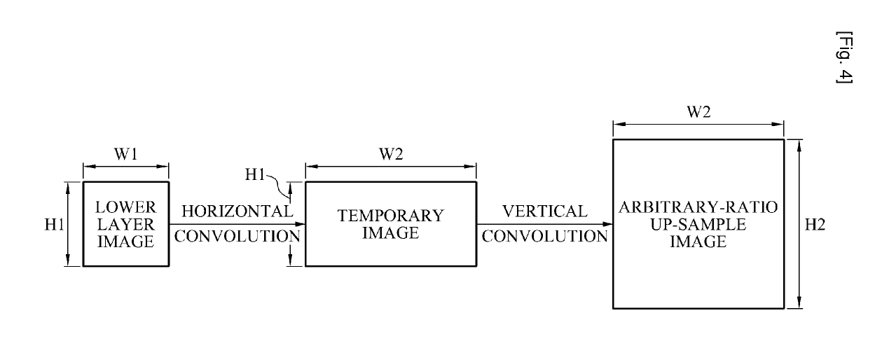

Each of the image up-sampling units 220 and 350 enlarges only an intra-MB from among MBs of the decoded or encoded low resolution image. Here, the image up-sampling is performed by a method defined in the H.264 SVC, and also performed through a convolution process using a 4-tap filter, as illustrated in FIG. 4.

Each of the image up-sampling units 220 and 350 determines a MB mode of the low-order layer using characteristics of a single-loop-decoding mode of the H.264 SVC, and then an image up-sampling is performed adaptively according to the determined MB mode. In this instance, the characteristics of the single-loop-decoding mode denote such that the high-order layer has an intra base-layer (BL) mode only when the low-order layer is an intra MB.

The high-order layer encoding unit 230 subtracts a pixel value of a corresponding residual block of the up-sampled low-order layer from a pixel value of a residual block of the high-order layer to thereby be encoded in the MB of the high-order layer.

The high-order layer decoding unit 360 adds the pixel value of the corresponding residual block of the up-sampled low-order layer to the pixel value of the residual block of the high-order layer to thereby be decoded in the MB of the high-order layer.

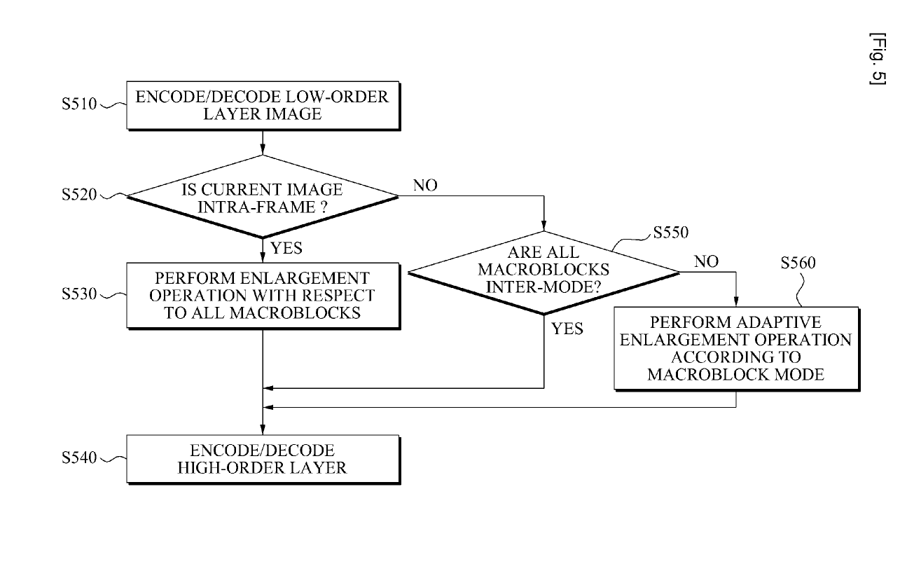

FIG. 5 is a flowchart illustrating a scalable video encoding/decoding method according to an exemplary embodiment of the present invention.

Referring to FIG. 5, the scalable video encoding/decoding method includes operation S510 for encoding/decoding a low resolution image of a low-order layer, operation S520 for determining whether encoded/decoded data (frame) of the low resolution image is intra-data, operation S560 for determining a MB mode of the encoded/decoded data to thereby enlarge only an intra-MB when the encoded/decoded data of the low resolution image is different from the intra-data, and operation S540 for encoding/decoding a high resolution image using the enlarged intra-MB. Here, the scalable video encoding method and the scalable video decoding method are performed in the similar manner to each other. Thus, for the convenience of the description, the scalable video encoding method will be mainly described in detail.

First, in operation S510, the low-order layer encoding unit 210 encodes a low-order layer image.

In operation S520, the image up-sampling unit 220 determines whether the encoded low-order layer image is an intra-frame. In operation S530, an enlargement operation is performed with respect to all MBs when the low-order layer image is the intra-frame, because all MBs of the low-order layer image are the intra-frame.

In operation S550, the image up-sampling unit 220 determines whether the all MBs are an inter-mode when the encoded low-order layer image is different from the intra-frame. In operation S540, the enlargement operation is omitted, and a high-order layer image is encoded, when the all MBs are the inter-mode.

In operation S560, the image up-sampling unit 220 performs an adaptive enlargement operation according to the MB mode when the all MBs of the low-order layer image are different from the inter-mode, that is, when at least one of the low-order layer images includes an intra-MB.

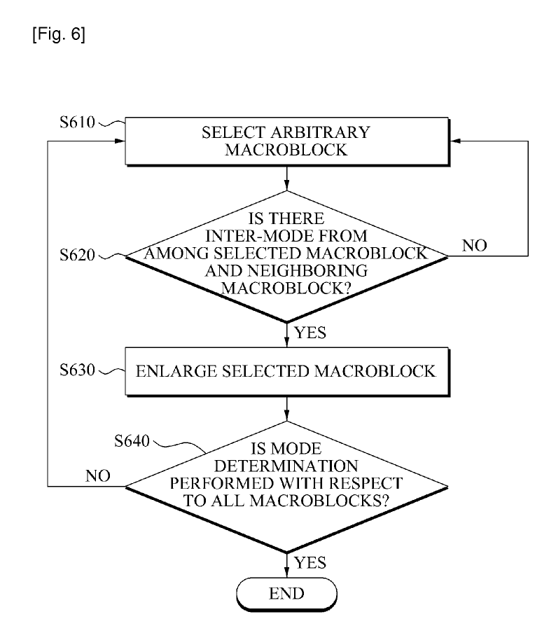

FIG. 6 is a flowchart illustrating an adaptive image up-sampling operation process of FIG. 4, in detail.

Referring to FIG. 6, the adaptive image up-sampling operation process includes operations S610 and S620 for determining whether at least one of an arbitrary MB and respective neighboring MBs is the intra-MB, and operation S630 for enlarging the arbitrary MB when the at least one of the arbitrary MB and the respective neighboring MBs is the intra-MB.

Specifically, in operation S610, an arbitrary MB is selected in order to determine sequentially a mode with respect to each of MBs of the low-order layer.

Next, in operation S620, whether at least one of the selected MB and neighboring MBs is the intra-MB is determined. In operation S530, the arbitrary MB is enlarged when the at least one of the selected MB and the neighboring MBs is the intra-MB. Also, a mode determination with respect to a sequent MB is performed in the same manner as above when the at least one of the selected MB and the neighboring MBs is different from the intra-MB. Specifically, when any one from among the neighboring MBs is the intra-MB although the selected MB is different from the intra-MB, the selected MB is enlarged.

Next, in operation S640, whether a mode determination is completed with respect to all MBs of the low-order layer image is determined. The high-order layer image is encoded when the adaptive enlargement process is completed with respect to the all MBs.

According to the present exemplary embodiment, in operation S630, the selected MB is enlarged first in a horizontal direction, and then in a vertical direction, respectively.

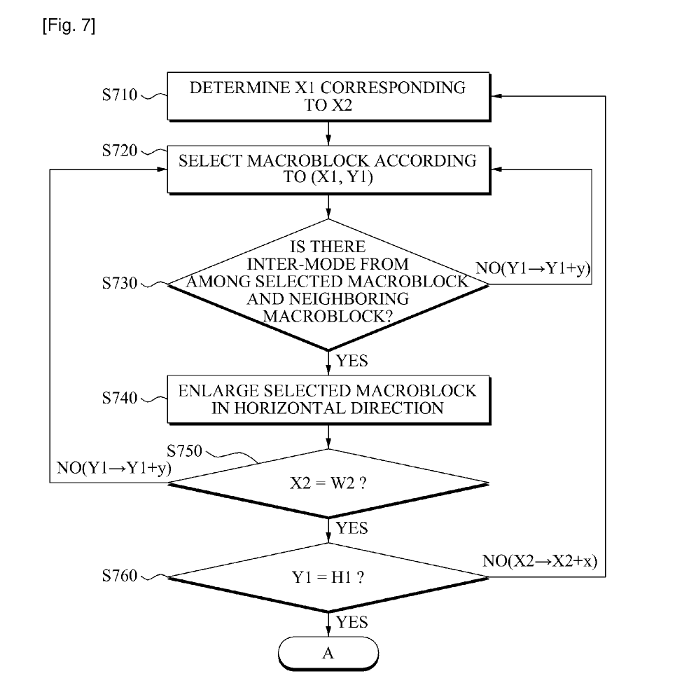

FIG. 7 is a flowchart illustrating a method for up-sampling an image according to an exemplary embodiment of the present invention.

As illustrated in FIG. 7, an arbitrary MB is selected in a low-order layer, and the selected MB is enlarged in the horizontal direction.

In operation S710, the image up-sampling unit 220 determines X1 of a horizontal coordinate with respect to a MB the low-order layer corresponding to X2 of a horizontal coordinate with respect to a MB of the high-order layer.

As can been seen from FIG. 4, a relation between X1 and X2 may be represented by

$$X 1 = \frac{X 2 \times W 1}{16 \times W 2} \qquad [ Equation 1 ]$$

where W1 denotes a horizontal length of the low-order layer. In this instance, W1 is assumed to be identical to a maximum of X1. Also, W2 denotes a vertical length of the high-order layer. Maximums of W2 and X2 are assumed to be identical to each other.

In operation S720, the image up-sampling unit 220 selects a MB of the low-order layer according to X1 and Y1 corresponding to X2. Here, Y1 denotes a vertical coordinate of the low-order layer. It is assumed that each of initial values of X2 and Y1 is x2 and y1, respectively. In this instance, each of x2 and y1 corresponds to a size of the MB of the high-order layer and the low-order layer, respectively.

In operation S730, the image up-sampling unit 220 determines whether an inter-mode exists from among the MB corresponding to the initial values of x2 and y1 and the neighboring MBs.

The image up-sampling unit 220 increments Y1 by y1 and then selects a MB when the inter-mode does not exist from among the MB and the neighboring MBs according to the determination result of operation S730.

In operation S740, the image up-sampling unit 220 enlarges the selected MB in the horizontal direction when the inter-mode exists from among the MB and the neighboring MBs according to the determination result of operation S730.

Next, in operations S750 and S760, the image up-sampling unit 220 determines whether a mode determination is completed with respect to MBs of the all low-order layers.

In this instance, in operation S750, the image up-sampling unit 220 determines that X2=W2. W2 is assumed to be a maximum of X2 of the horizontal coordinate of the high-order layer. When X2≠W2, the image up-sampling unit 220 increments Y1 by y1 and then selects a MB.

In this instance, in operation S760, the image up-sampling unit 220 determines whether Y1=H1. H1 denotes a horizontal length of the low-order layer. Also, H1 is assumed to be identical to a maximum of Y1. When Y1≠H1, the image up-sampling unit 220 increments X2 by x2, and then returns to operation S710. Here, x2 corresponds to a horizontal length of the MB of the high-order layer.

A horizontal enlargement of the low-order layer is completed when operations 710 to 740 are performed with respect to all of X2 and Y1.

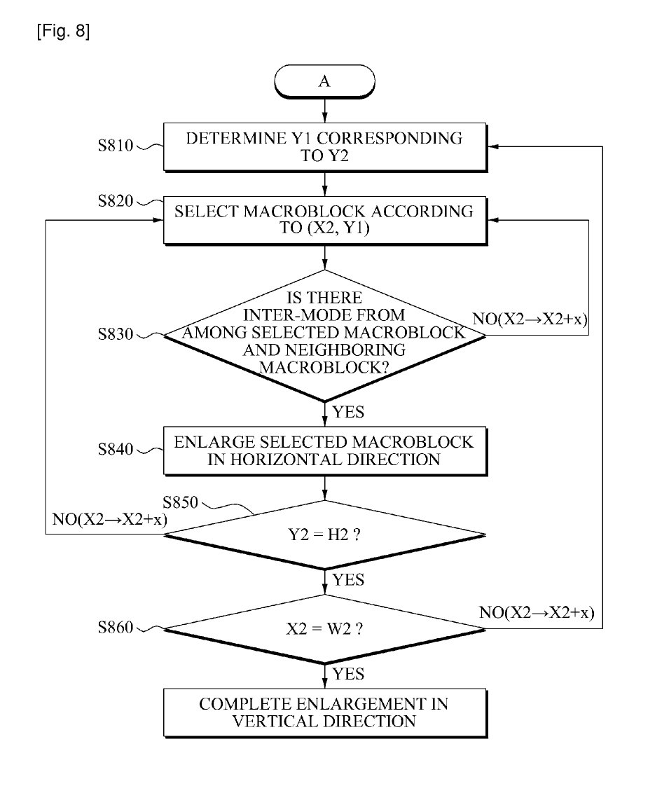

FIG. 8 is a flowchart illustrating a method for up-sampling an image according to another exemplary embodiment of the present invention.

As illustrated in FIG. 8, an arbitrary MB is selected in a low-order layer, and the selected MB is enlarged in the vertical direction. Here, it is assumed that a vertical enlargement is performed after the horizontal enlargement is completed.

In operation S810, the image up-sampling unit 220 determines Y1 of a vertical coordinate of the low-order layer corresponding to Y2 of a vertical coordinate with respect to a MB of the high-order layer.

As can be seen from FIG. 4, a relation between Y1 and Y2 may be represented by

$$Y 1 = \frac{Y 2 \times H 1}{16 \times H 2} \qquad [ Equation 2 ]$$

where H2 denotes a vertical length of the high-order layer. In this instance, H2 is assumed to be identical to a maximum of Y2.

In operation S820, the image up-sampling unit 220 selects a MB of the low-order layer of W2×H1 enlarged in the horizontal direction according to Y1 and X2 corresponding to Y2. It is assumed that each of initial values of X2 and Y2 is x2 and y2. In this instance, y2 corresponds to a size of the MB of the high-order layer.

In operation S830, the image up-sampling unit 220 determines whether an inter-mode exists from among the MB corresponding to the initial values of x2 and y2 and the neighboring MBs.

The image up-sampling unit 220 increments X2 by x2 and then selects a MB when the inter-mode does not exist from among the MB and the neighboring MBs according to the determination result of operation S830.

In operation S840, the image up-sampling unit 220 enlarges the selected MB in the vertical direction when the inter-mode exists from among the MB and the neighboring MBs according to the determination result of operation S830.

Next, in operations S850 and S860, the image up-sampling unit 220 determines whether a mode determination is completed with respect to MBs of the all low-order layers of W2×H1.

In this instance, in operation S850, the image up-sampling unit 220 determines that Y2=H2. When Y2≠H2, the image up-sampling unit 220 increments Y2 by y2 and then returns to operation S810.

A vertical enlargement of the low-order layer having been enlarged in the horizontal direction is completed when operations 810 to 840 are performed with respect to all of X2 and Y2.

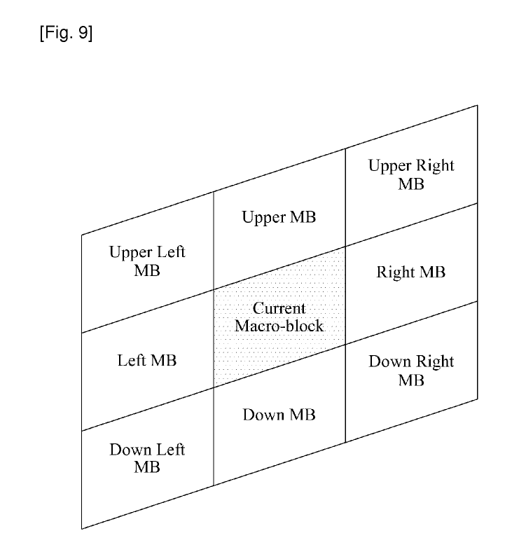

As illustrated in FIG. 9, the neighboring MBs are positioned, respectively, in upper, upper-left, upper-right, lower, lower-left, lower-right, left, and right sides with respect to an arbitrary MB. Here, the neighboring MBs are determined considering a padding process for the image up-sampling.

It is assumed that Equations 1 and 2 are applicable to a luminance. Also, an appropriate scaling scheme other than Equations 1 and 2 may be applicable to a chrominance.

The method for up-sampling a low resolution image corresponding to a high resolution image having an arbitrary image up-sampling ratio according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, according to the present invention, there is provided the method for up-sampling an image, which can perform an up-sampling only with respect to the low-order layer image satisfying a predetermined condition, while the conventional method performs an up-sampling with respect to all of encoded/decoded low-order layer images.

A ratio of intra-MB to a general video compression sequence is about 5 to 10%. Accordingly, the present invention can reduce an operation amount of up-sampling of the low-order layer image.

Also, according to the present invention, there are provided scalable video encoding/decoding apparatus and method where the method for up-sampling the image is adapted, which can reduce an operation amount of up-sampling performed at the time of encoding/decoding, thereby reducing a time required for the encoding and decoding, and improving performance of a system.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for up-sampling a low resolution image corresponding to a high resolution image having an arbitrary image up-sampling ratio, the method comprising:
determining whether the low resolution image is inter-mode data; and
performing an image up-sampling adaptively according to a macroblock mode of the low resolution image, when the low resolution image is the inter-mode data.

2. The method of claim 1, wherein the performing includes:
determining whether an arbitrary macroblock of the low resolution image and respective neighboring macroblocks adjacent to the arbitrary macroblock are an intra-macroblock; and
enlarging the arbitrary macroblock when at least one of the arbitrary macroblock and the respective neighboring macroblocks is the intra-macroblock.

3. The method of claim 2, wherein the determining and the enlarging are performed, respectively, with respect to another macroblock of the low resolution image, when the arbitrary macroblock and the respective neighboring macroblocks are different from the intra-macroblock.

4. The method of claim 2, wherein the enlarging includes:
enlarging the arbitrary macroblock in a horizontal direction; and
enlarging, in the vertical direction, the arbitrary macroblock enlarged in the horizontal direction.

5. The method of claim 2, wherein the respective neighboring macroblocks are positioned, respectively, in upper, upper-left, upper-right, lower, lower-left, lower-right, left, and right sides with respect to the arbitrary macroblock.

6. A scalable video encoding apparatus, comprising:
a low-order layer encoding unit for encoding a low resolution image corresponding to an arbitrary high resolution image;
an image up-sampling unit for up-sampling an image adaptively according to a macroblock mode of the encoded low resolution image; and
a high-order layer encoding unit for encoding the high resolution image using a difference between the up-sampled image and the high resolution image.

7. The scalable video encoding apparatus of claim 6, wherein the image up-sampling unit enlarges only an intra-macroblock from among macroblocks of the encoded low resolution image.

8. The scalable video encoding apparatus of claim 7, wherein the intra-macroblock is enlarged in the horizontal direction, and the intra-macroblock enlarged in the horizontal direction is enlarged in the vertical direction.

9. A scalable video decoding apparatus, comprising:
a low-order layer decoding unit for decoding a low resolution image corresponding to an arbitrary high resolution image;
an image up-sampling unit for up-sampling an image adaptively according to a macroblock mode of the decoded low resolution image; and
a high-order layer decoding unit for decoding the high resolution image using the up-sampled image and a residual encoded data of the high resolution image.

10. The scalable video decoding apparatus of claim 9, wherein the image up-sampling unit enlarges only an intra-macroblock from among macroblocks of the decoded low resolution image.

11. The scalable video decoding apparatus of claim 10, wherein the intra-macroblock is enlarged in the horizontal direction, and the intra-macroblock enlarged in the horizontal direction is enlarged in the vertical direction.

12. A scalable video encoding method using a low resolution image corresponding to an arbitrary high resolution image, the scalable video encoding method comprising:
determining whether encoded data of the low resolution image is intra-data;
determining a macroblock mode of the encoded data to enlarge only an intra-macroblock, when the encoded data of the low resolution image is different from the intra-data; and
encoding the high resolution image using the enlarged macroblock.

13. The scalable video encoding method of claim 12, wherein the determining of the microblock mode includes:
determining whether at least one of an arbitrary macroblock of the low resolution image and respective neighboring macroblocks adjacent to the arbitrary macroblock are an intra-macroblock; and
enlarging the arbitrary macroblock when at least one of the arbitrary macroblock and the respective neighboring macroblocks is the intra-macroblock.

14. The scalable video encoding method of claim 13, wherein the enlarging includes:
enlarging the arbitrary macroblock in the horizontal direction; and
enlarging, in the horizontal direction, the arbitrary macroblock enlarged in the horizontal direction.

15. A scalable video decoding method using a low resolution image corresponding to an arbitrary high resolution image, the scalable video decoding method comprising:
determining whether decoded data of the low resolution image is intra-data;
determining a macroblock mode of the decoded data to enlarge only an intra-macroblock when the decoded data of the low resolution image is different from the intra-data; and
decoding the high resolution image using the enlarged macroblock.

16. The scalable video decoding method of claim 15, wherein the determining of the macroblock mode includes:
determining whether at least one of an arbitrary macroblock of the low resolution image and respective neighboring macroblocks adjacent to the arbitrary macroblock are an intra-macroblock; and
enlarging the arbitrary macroblock when at least one of the arbitrary macroblock and the respective neighboring macroblocks is the intra-macroblock.

17. The scalable video decoding method of claim 16, wherein the enlarging of the arbitrary macroblock enlarges the arbitrary macroblock in the horizontal direction, and enlarges, in the vertical direction, the arbitrary macroblock enlarged in the horizontal direction.
